(19) United States
(12) Patent Application Publication
(10) Pub. No.: US 2002/0067891 A1
(43) Pub. Date: Jun. 6, 2002

(54) Compact in-line multifunction optical component with multiple fiber terminated optical ports

(76) Inventor: Bo A. Andersen, Bridgewater, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/727,728

(22) Filed: Dec. 1, 2000

(51) Int. Cl. G02B 6/26

(52) U.S. Cl. 385/47; 385/45; 385/48

(57) ABSTRACT

An apparatus having multiple fiber terminated optical ports uses optical components such as isolators, reflectors, mirrors, and prisms to steer a beam of light to an optical port. The steered beam of light is approximately parallel to the main axis and has a small lateral offset. The optical components may be part of an integrated component or discrete. The apparatus may have multiple input fiber terminated optical ports and multiple output fiber terminated optical ports. The apparatus is especially amenable to planar packaging of optical components.

### FIELD OF THE INVENTION

The present invention relates to the field of fiber optics, and specifically to an apparatus and method for providing multiple fiber terminated optical ports.

### BACKGROUND

To meet the demand for increasing bit rates and circuit complexity, data communication systems require high density interconnections with high data throughput and low crosstalk. Meeting this demand often requires implementing parallel systems with more precise coupling and alignment techniques. Thus, automated assembly and circuit packaging play an increasingly more important role in the design process of data communication systems.

Packaging costs typically dominate the cost of optoelectronic modules in data communication systems. Many factors contribute to packaging costs. These factors include coupling efficiency, insertion loss, gain, noise, environmental requirements, thermal characteristics, power consumption, alignment tolerances, and the form factor such as planar package (flat), and cylindrical package. The form factor impacts component design and the automated assembly strategy.

Cylindrical packaging requires the optical components to be co-axial. Optical components must be precisely aligned to prevent components being off the main optical axis. Also, the addition of optical components and the types of optical components are limited in cylindrical packaging. Optical components which are very lossy are not appropriate for cylindrical packaging because a signal with adequate signal strength does not pass through to the next component. The use of components such as photodetectors must be carefully considered, because photodetectors typically do not allow an optical signal to pass through. Furthermore, component density is limited in a cylindrical module because each optical component is positioned along a main optical axis.

Assembly of cylindrical modules often requires that individual components be optically coupled by optical fiber. This typically requires fusion splicing of the optical fiber at various locations in the cylindrical module. Fusion splicing during the assembly process is time consuming and costly, and also contributes to insertion loss. Thus a need exists for a package which overcomes the above disadvantages.

### SUMMARY OF THE INVENTION

A compact in-line multifunction apparatus includes multiple fiber terminated optical ports. The apparatus comprises at least one input port for receiving at least one beam of input optical energy. The input port produces at least one beam of received optical energy. The apparatus further comprises at least one optical component which receives the optical energy and produces at least two beams of optical energy. At least one of the two beams is not co-axial with the received optical energy. The apparatus also comprises an output port for receiving at least one of the beams of directed optical energy and for producing at least one beam of output optical energy. None of the beams of output optical energy need be co-axial with the beam of input optical energy.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. The various features of the drawing are not to scale. On the contrary, the dimensions of the various features are arbitrarily expanded or reduced for clarity. Included in the drawing are the following figures:

FIG. 1 is plan view of an exemplary embodiment of the invention with multiple fiber terminated optical ports;

FIG. 2 is an exemplary embodiment of the invention using a prism to direct optical energy;

FIG. 3 is an exploded view of an optical component assembly having multiple fiber terminated optical ports in accordance with an exemplary embodiment of the present invention; and

FIG. 4 is a flow diagram describing an exemplary process to produce beams of optical energy in accordance with the present invention.

### DETAILED DESCRIPTION

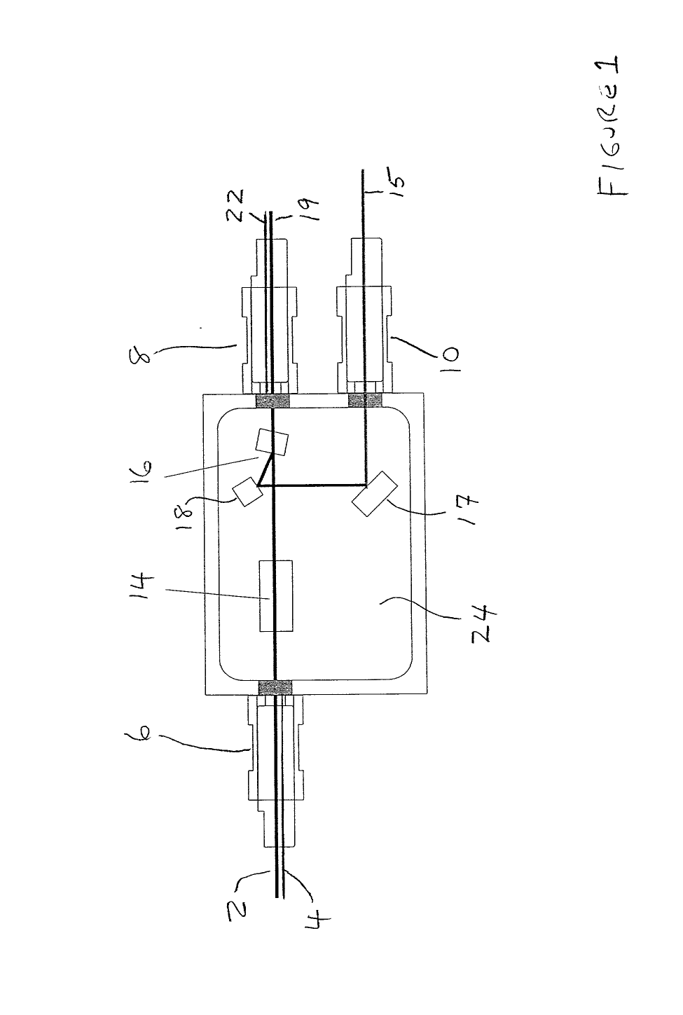

Referring now to the drawings, wherein like reference numbers refer to like elements throughout, FIG. 1 is plan view of an exemplary embodiment of the invention with multiple fiber terminated optical ports. FIG. 1 illustrates multiple optical fibers 2, 4, 22, 19, and 15; input port 6; multiple output ports 8 and 10; optical component region 24; and optical components 14, 16, 18, and 17.

In FIG. 1, input optical fibers 2 and 4 receive multiple beams of optical energy. Two input optical fibers are shown for illustrative purposes. The number of input optical fibers may be more or less than two. The source of the multiple beams of optical energy (not shown in FIG. 1) may be any source, for example, lasers, injection laser diodes (ILDs), or light emitting diodes (LEDs). The wavelength of the beams of optical energy may or may not be in the range of visible light. Each of the multiple sources need not be of the same type.

Output optical fibers 22, 19, and 15 produce beams of output optical energy. It is envisioned that the number of output optical fibers may differ from the number of output optical fibers shown in FIG. 1. The characteristics of each beam of output optical energy may differ. For example, the beams of optical energy within optical fibers 22, 19, and 15 my differ in frequency, phase, wavelength, polarization and/or intensity. The characteristic differences are due, in part, to the types of optical components retained in region 24. In an exemplary embodiment of the invention, the beams of output optical energy are approximately parallel. Approximately parallel beams of output optical energy facilitate system design by allowing efficient placement of adjacent packages.

Input port 6 couples the input optical fibers 2 and 4 to optical component region 24. Output port 8 couples output optical fibers 22 and 19 to optical component region 24, and output port 10 couples output optical fiber 15 to optical component region 24. Input port 6 and output ports 8 and 10, may be any coupling device, or combination of coupling devices. In an exemplary embodiment of the invention, the input and output ports comprise collimated lens assemblies. Each collimated lens assembly may comprise combinations of several components, such as lenses, filters, ferrules, and wavelength division multiplexers (WDMs).

Region 24 may have positioned therein any combination of optical components. Examples of optical components which may be retained in region 24 include lenses, reflectors, isolators, taps, and WDMs. In an exemplary embodiment of the invention, element 14 is an isolator, elements 18 and 17 are reflectors, and element 16 is a tap. Elements 16, 18 and 17 perform the functions of filtering and routing optical energy. These functions may also be accomplished with a prism.

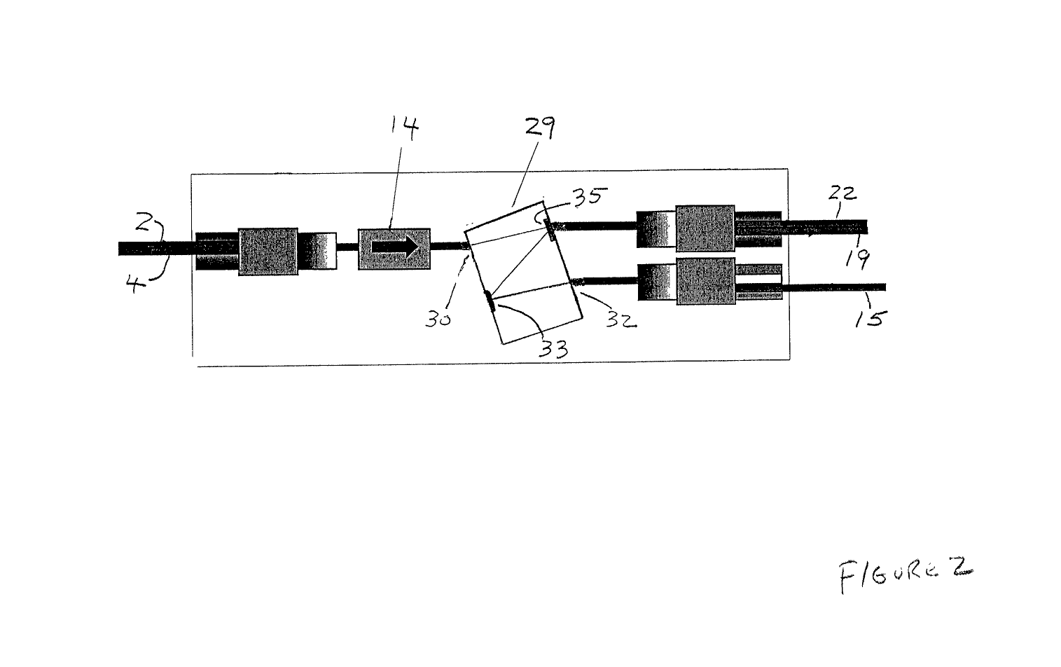

FIG. 2 is an exemplary embodiment of the invention using a prism to direct optical energy. In FIG. 2, prism 29 filters and directs optical energy to optical fibers 22, 19, and 15. In an exemplary embodiment of the invention, prism 29 comprises an anti-reflective coating on a portion of its outer surfaces, 30 and 32, and a reflective coating, such as a mirror, on a portion of its inner surface 33. Surface area 35 comprises a tap coating, which allows a portion of optical energy to be reflected and also allows a portion of optical energy to pass through the surface. Optical energy transmitted through isolator 14 enters prism 29 through surface 30. This optical energy is coupled to surface area 35 which passes a portion of the optical energy to optical fibers 22 and 19, and reflects a portion of the optical energy to surface 33. Surface area 33 reflects optical energy toward optical fiber 15. This optical energy is coupled to optical fiber 15 through surface area 32.

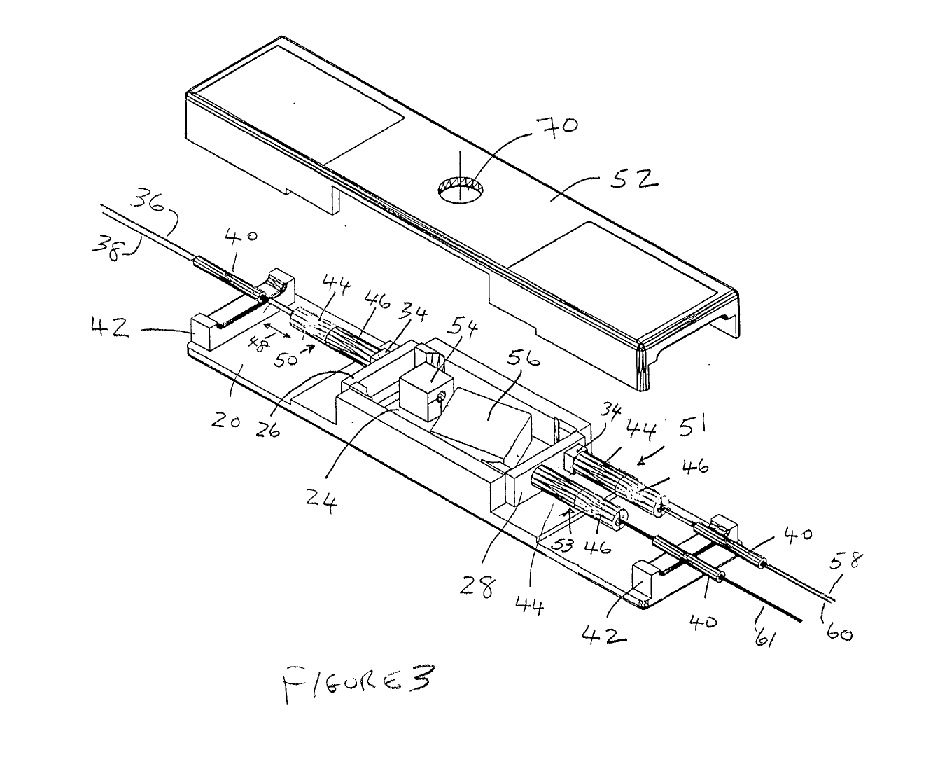

FIG. 3 is an exploded view of an optical component assembly having multiple fiber terminated optical ports in accordance with an exemplary embodiment of the present invention. Optical fibers 36 and 38 are attached to collimated lens assembly 50. Collimated lens assemblies are used to optically couple energy between optical fibers and optical components. As shown in FIG. 3, collimated lens assemblies 50, 51, and 53 optically couple energy between optical fibers and components 54 and 56 positioned in region 24, through windows 26 and 28.

Collimated lens assemblies may comprise combinations of several components, such as lenses, filters, ferrules, and wavelength division multiplexers (WDMs). Exemplary collimated lens assembly 50 comprises a ferrule 44, a lens 46, and an optical filter 34. Ferrule 44 is a cylindrical device having apertures sized to fit optical fibers 36 and 38. Optical fibers 36 and 38 are mounted in ferrule 44. Ferrule 44 centers and aligns optical fibers 36 and 38. Optical fibers 36 and 38 are terminated within ferrule 44. Typically, cylindrical ferrules are limited to housing no more than two optical fibers because of the strict tolerances associated with transferring optical energy between a pair of optical fibers. Lens 46 focuses optical energy.

Lens 46 may comprise any suitable lens, such as a gradient radial index (hereinafter GRIN) lens, a molded aspheric lens, or a ground spherical lens. In the exemplary embodiment shown in FIG. 3, lens 46 is a GRIN lens. Note that collimated lens assemblies 50 and 51 each comprise filter 34 attached to the lens of the collimated lens assembly. Filter 34 is optional. Note that collimated lens assembly 53 does not comprise a filter. Depending upon system requirements, other optical components (e.g., WDM) may be positioned between the lens of the collimated lens assembly and the window.

Collimated lens assembly 50 is attached to window 26 and collimated lens assemblies 51 and 53 are attached to window 28. The attachment of collimated lens assembly 50 with window 26 and collimated lens assemblies 51 and 53 with window 28, may be by any appropriate means, such as through the use of an adhesive (e.g., optical quality heat cured epoxy MH77A). Adhesively attaching the collimated lens assemblies to the windows does not require sustained localized heating, in contrast to soldering and laser welding. Therefore components are not as susceptible to heat damage. Also, because adhesively attaching the collimated lens assemblies to the window does not require access by a laser welder, more collimated lens assemblies can be adhered to the window. Furthermore, windows 26 and 28 may be adjusted in size to accommodate any number of collimated lens assemblies and therefore, more optical fibers. Additionally, the curing process associated with adhesively attaching the collimated lens assemblies to the windows does not misalign the components to the same degree as does post weld shift. Thus the alignment procedure associated with adhesively attaching collimated lens assemblies to the windows is less time consuming and more easily accomplished than the alignment process associated with laser welding.

Optical fibers 36 and 38 are axially positioned within bend limiter tubing 40. Bend limiter tubing 40 is a hollow, generally cylindrical sleeve through which optical fibers 36 and 38 are positioned to limit the bending of the optical fibers. In an exemplary embodiment of the invention, optical fibers 36 and 38 are attached to the inner surface of bend limiter tubing 40 with a filler material. The filler material may comprise, for example, a commercially available pliable adhesive (e.g., silicone). Attaching optical fibers 36 and 38 to the inner surface of bend limiter tubing 40 facilitates the automated assembly process by reducing the motion of optical fibers 36 and 38. The filler material reduces axial motion of optical fibers 36 and 38 in the directions indicated by arrow 48. Axial motion may be caused by mechanical strain applied to optical fibers 36 and 38 during the assembly process. Axial motion may also be caused by expansion and contraction of optical fibers 36 and 38, and/or other components, due to thermal variation. Excessive axial motion may cause optical fibers 36 and 38 to bend and ultimately sustain damage. The filler material also reduces radial motion of optical fibers 36 and 38, thus reducing the possibility of any damage due to radial motion.

Support member 42 provides support for bend limiter tubing 40 and optical fibers 36 and 38. In an exemplary embodiment of the invention, optical fibers 36 and 38 are rigidly attached to collimated lens assembly 50. This rigid attachment also contributes to the bending of optical fibers 36 and 38 when subjected to axial motion. The support provided by support member 42 reduces bending of optical fibers 36 and 38, and reduces the possibility of optical fibers 36 and 38 becoming detached from collimated lens assembly 50. In an exemplary embodiment of the invention, bend limiter tubing 40 is attached to support member 42. Attachment of bend limiter tubing 40 to support member 42 may be achieved through the use of, for example, an adhesive such as epoxy. Attachment of bend limiter tubing 40 to support member 42 facilitates the automated assembly process by reducing movement of bend limiter tubing 40, which in turn reduces movement of optical fibers 36 and 38.

Region 24 may retain any combination of optical components. Optical components 54 and 56 represent exemplary optical components which may be retained in region 24, examples of which include lenses, reflectors, isolators, taps, and WDMs. In the exemplary embodiment of the invention shown in FIG. 3, optical component 54 is an isolator and optical component 56 is a prism. In this embodiment, isolator 54 ensures that optical energy is directed toward optical component 56 with minimal reflection of optical energy back toward collimated lens assembly 50. Optical energy which has interacted with isolator 54 is directed toward prism 56. Prism 56, apportions and routes the optical energy received from isolator 54 to collimated lens assemblies 51 and 53.

In an exemplary embodiment of the invention, prism 29 comprises an anti-reflective coating on a portion of its outer surfaces, 30 and 32, and a reflective coating, such as a mirror, on a portion of its inner surface 33. Surface area 35 comprises a tap coating, which allows a portion of optical energy to be reflected and also allows a portion of optical energy to pass through the surface. Optical energy transmitted through isolator 14 enters prism 29 through surface 30. This optical energy is coupled to surface area 35 which passes a portion of the optical energy to optical fibers 22 and 19, and reflects a portion of the optical energy to surface 33. Surface area 33 reflects optical energy toward optical fiber 15. This optical energy is coupled to optical fiber 15 through surface area 32.

Isolator 54 and prism 56 form a free air space optical network. Optical energy is coupled between window 26 and isolator 54, between isolator 54 and prism 56, and between prism 56 and window 28, through air. A free air space optical network may not be appropriate in an environment with high ambient optical energy. In high ambient optical energy environments, it is advantageous to provide a cover, such as upper portion 52 over region 24. Upper portion 52 also protects optical components within region 24 from damage (e.g., dust, collision, contamination) during storage, shipping, and use. Hole 70, in upper portion 52 may remain open or be filled with material. An example of a filler material for hole 70 is a membrane comprising a wicking agent to withdraw moisture from region 24.

Upper portion 52 is positioned opposite base structure 20 and support members 42. Upper portion 52 is attached to base structure 20 and/or support member 42. Attachment of upper portion 52 to base structure 20 and/or support member 42 may be accomplished by any means known in the art (e.g., adhesives, press fit, or snaps). Bend limiting tubing 40 is positioned between support member 42 and upper portion 52. Positioning bend limiting tubing 40 between support member 42 and upper portion 52 facilitates the automated assembly process by limiting movement of bend limiting tubing 40 and optical fibers 36 and 38.

Bend limiter tubing 40 is positioned around each group of optical fibers coupled to the optical component housing. Placing bend limiter tubing around all optical fibers facilitates the automated assembly process by reducing fiber motion. Support members 42 provide support for all bend limiter tubes 40. Supporting all bend limiter tubes 40 with support member 42 facilitates the automated assembly process by reducing motion of the optical fibers and bend limiter tubing. In various embodiments of the invention, bend limiting tubing 40 is attached to support member 42 and/or upper portion 52. Attachment of bend limiter tubing 40 to support member 42 and/or upper portion 52 may be achieved through the use of, for example, an adhesive such as epoxy, or a press fit. Attachment of bend limiter tubing 40 to support member 42 and/or upper portion 52 facilitates the automated assembly process by reducing movement of bend limiter tubing 40, which in turn reduces movement of optical fibers 36 and 38.

It is emphasized that the embodiment of the invention shown in FIG. 3 is exemplary. FIG. 3 shows two optical fibers, 36 and 38. FIG. 3 shows support member 42 as an integral part of base structure 20. It is envisioned that base structure 20 and support member 42 may be separate, but rigidly attached by any appropriate means such as adhesively, snap fit, press fit, or bolted.

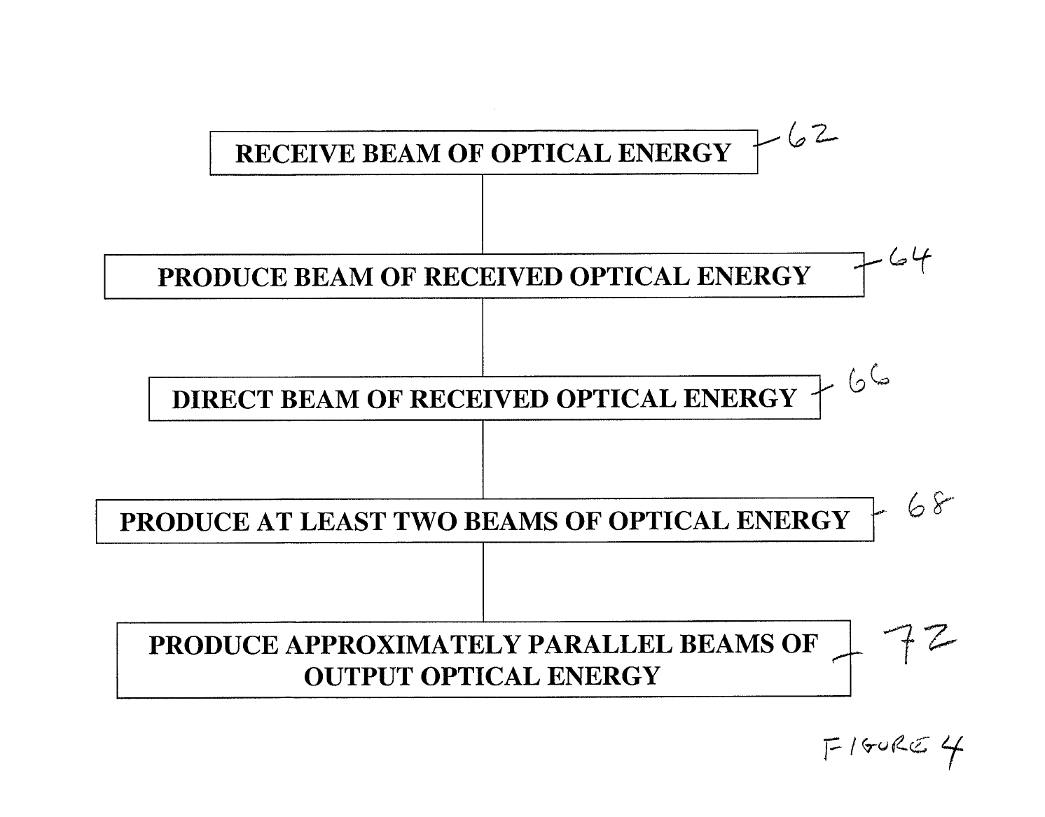

FIG. 4 is a flow diagram describing an exemplary process to produce beams of optical energy in accordance with the present invention. The steps in FIG. 4 are described with reference to the elements in FIG. 3. In step 62, input optical energy is provided to the input port via optical fibers 36 and 38. The input optical energy is collimated and focused by collimated lens assembly 50 and lens 34 to produce received optical energy. The received optical energy, as described in step 64, is directed toward optical component 54, as described in step 66. Isolator 54 ensures that the optical energy is directed toward optical component 56 with minimal reflection of optical energy back toward the input port. Optical energy which has interacted with optical component 54 is directed toward optical component 56. In accordance with steps 66 and 68, optical component 56 directs portions of the optical energy toward collimated lens assemblies 51 and 53. The beams of output optical energy, within optical fibers 58, 60, and 61, are offset from each other and are approximately parallel with the beams of input optical energy, as described in step 72. Further, none of the beams of output optical energy are required to be co-axial with the beam of input optical energy, which is in contrast to cylindrical optical packages.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. An optical component assembly having multiple fiber terminated ports, said optical assembly comprising:
at least one input port for receiving at least one beam of input optical energy and producing at least one beam of received optical energy;
at least one optical component optically coupled to the received optical energy for producing at least two beams of optical energy; and
a plurality of output ports for receiving said at least two beams of optical energy and for producing a plurality of beams of output optical energy, wherein at least one of said plurality of beams of output optical energy is not co-axial with the at least one beam of input optical energy.

2. The optical component assembly in accordance with claim 1 wherein the plurality of beams of output optical energy are approximately parallel.

3. The optical component assembly in accordance with claim 1 wherein at least two of the plurality of beams of output optical energy differ in at least one characteristic.

4. The optical component assembly in accordance with claim 1 wherein at least two of the plurality of beams of output optical energy differ in at least one of frequency, phase, wavelength, polarization, and intensity.

5. The optical component assembly in accordance with claim 1 wherein said optical component comprises at least one of an isolator, a tap, a reflector, a prism, a wavelength division multiplexer, and a filter.

6. The optical component assembly in accordance with claim 1, wherein said prism comprises:
a first side having an inner surface and an outer surface, said outer surface of said first side having an anti-reflective coating and said inner surface of said first side having a reflective coating,
a second side opposite said first side, said second side having an inner surface and an outer surface, a portion of said inner surface of said second side having a tap coating, said outer surface of said second side having an anti-reflective coating, wherein said received optical energy is coupled to said first side and said second side is optically coupled to said at least two beams of optical energy.

7. The optical component assembly in accordance with claim 1 wherein the at least one optical component is configured in a planar geometry.

8. The optical component assembly in accordance with claim 1 further comprising an input optical fiber optically coupled to said input port and a plurality of output optical fibers optically coupled to said plurality of output ports.

9. A method for producing a plurality of beams of output optical energy comprising the steps of:
receiving at least one beam of input optical energy for producing at least one beam of received optical energy;
directing a portion of the at least one beam of received optical energy to at least one optical component optically coupled to the received optical energy for producing at least two beams of optical energy; and
receiving said at least two beams of optical energy for producing said plurality of beams of output optical energy, wherein each of said plurality of beams of output optical energy is not co-axial with the at least one beam of input optical energy.

10. A method in accordance with claim 9 wherein said plurality of beams of output optical energy are approximately parallel.

11. A method in accordance with claim 9 wherein at least two of the plurality of beams of output optical energy differ in at least one characteristic.

12. A method in accordance with claim 9 wherein at least two of the plurality of beams of output optical energy differ in at least one of frequency, phase, wavelength, polarization, and intensity.

13. A method in accordance with claim 9, wherein said optical component comprises at least one of an isolator, a tap, a reflector, a prism, a wavelength division multiplexer, and a filter.

14. A method in accordance with claim 9, wherein the step of receiving at least one beam of input optical energy comprises receiving at least one beam of input optical energy through an input optical fiber; said method further comprising the step of optically coupling said plurality of beams of output optical energy to a plurality of output optical fibers.

15. An apparatus for producing a plurality of beams of output optical energy comprising:
means for receiving at least one beam of input optical energy for producing at least one beam of received optical energy;
means for directing a portion of the at least one beam of received optical energy to at least one optical component optically coupled to the received optical energy for producing at least two beams of optical energy; and
means for receiving said at least two beams of optical energy for producing said plurality of beams of output optical energy, wherein each of said plurality of beams of output optical energy is not co-axial with the at least one beam of input optical energy.

16. An apparatus in accordance with claim 15 wherein the plurality of beams of output optical energy are approximately parallel.

17. The apparatus in accordance with claim 15 wherein at least two of the plurality of beams of output optical energy differ in at least one characteristic.

18. The apparatus in accordance with claim 15 wherein the at least one characteristic comprises at least one of frequency, phase, wavelength, polarization, and intensity.

19. The apparatus in accordance with claim 15 wherein the at least one optical component comprises at least one of an isolator, a tap, a reflector, a prism, a wavelength division multiplexer, and a filter.

20. The apparatus in accordance with claim 15 wherein the at least one optical component is configured in a planar geometry.

21. The apparatus in accordance with claim 15, wherein said means for receiving at least one beam of input optical energy comprises means for receiving at least one beam of input optical energy through an optical fiber; said apparatus further comprising a means for optically coupling a plurality of optical fibers to said plurality of beams of output optical energy.
